(19) United States
(12) Patent Application Publication
(10) Pub. No.: US 2024/0045960 A1
(43) Pub. Date: Feb. 8, 2024

(54) COMPUTING DEVICE AND METHOD FOR THE SAME

(71) Applicant: ALIBABA (CHINA) CO., LTD., ZHEJIANG PROVINCE (CN)

(72) Inventors: SHIJIAN ZHANG, Beijing (CN); LIDE DUAN, SUNNYVALE, CA (US)

(21) Appl. No.: 18/063,875

(22) Filed: Dec. 9, 2022

(30) Foreign Application Priority Data
Aug. 8, 2022 (CN) 202210942345.3

(51) Int. Cl. G06F 21/56; G06F 21/52; G06F 12/06

(52) U.S. Cl. CPC G06F 21/566; G06F 21/52; G06F 12/06; G06F 2221/033

(57) ABSTRACT

A computing device includes a processor, at least one storage block, and an access detection unit. The processor includes a load/store unit (LSU). When the processor switches from a program to another program, the LSU stores a return address of the another program to the at least one storage block. The access detection unit includes a store-once stack and a comparison logic circuit. The store-once stack stores a storage address of the return address in the at least one storage block when the at least one storage block stores the return address. Before the LSU performs a storage operation on the at least one storage block, the comparison logic circuit compares a write address of the storage operation with a storage addresses of the return address stored in the store-once stack to determine whether the return address will be modified.

### CROSS-REFERENCE TO RELATED APPLICATIONS

This application claims priority of China application No. 202210942345.3, filed on Aug. 8, 2022, which is incorporated by reference in its entirety.

### BACKGROUND OF THE PRESENT DISCLOSURE

### Field of the Present Disclosure

The present disclosure relates to computing device and, more particularly, to a computing device capable of detecting return-oriented programming attacks.

### Description of the Prior Art

In general, when a program code executed by a computing device has to call another program or jump to another program, the computing device will store, from the bottom of a call stack, input parameters of the new program and a return address that the computing device should return to once the new program is completed. Furthermore, the computing device will further reserve storage space in the call stack for data required by the computation of the new program. Since the computing device will sequentially use the storage spaces of the call stack from top to bottom for storing the data generated or received during the execution of the new program, the return addresses might be overlapped by other data if the computing device does not perform check the boundary condition while storing the data to the call stack. In such case, after executing the new program, the computing device will not be able to go back to the initial program, and may even end up entering a wrong code segment, which causes system failure.

Return-oriented programming (ROP) is an attack technique that controls the computing device to execute malicious code by overwriting the return addresses stored in the call stack. To resist return-oriented programming attacks, prior art entails backing up return addresses when compiling the program code, and detecting the return-oriented programming attack by checking if the return address in the call stack is identical to the return address backed up when reading the return addresses from the call stack. However, compilation of the program code is mostly related to the operating system (OS) of the computing device, and thus, not only involves plenty modifications but also fails to protect low-level function libraries. Therefore, it is imperative to provide a computing device capable of effectively detecting return-oriented programming attacks.

### SUMMARY OF THE PRESENT DISCLOSURE

One embodiment of the present disclosure discloses a computing device. The computing device includes at least one storage block, a processor, and an access detection unit. The processor is configured to execute a program and comprising a load/store unit, wherein, when the processor exits the program and enters another program, the load/store unit stores a return address that the processor should return to after the another process finishes to the at least one storage block. The access detection unit includes a store-once stack, and a comparison logic circuit. The store-once stack is configured to store a storage address of the return address in the at least one storage block when the at least one storage block stores the return address. The comparison logic circuit is configured to, before the load/store unit performs a storage operation on the at least one storage block to store a value, compare a write address of the storage operation with at least one storage addresses of at least one return address stored in the store-once stack to determine whether the storage operation is about to modify the at least one return address, and, upon an affirmative determination, and issue an error-alert signal to prevent the load/store unit from performing the storage operation and storing the value to the write address of the at least one storage block.

Another embodiment of the present disclosure discloses a method for a computing device. The computing device includes at least one storage block and a store-once stack. The method includes: storing, upon completion of a program and ensuing commencement of execution of another program, a return address of the another program to the at least one storage block; storing, when at least one storage block stores the return address, a storage address of the return address in the at least one storage block to the store-once stack; executing the another program; comparing, prior to performing a storage operation on the at least one storage block to push in a value, a write address of the at least one storage block with at least one storage address of at least one return address stored in the store-once stack to determine whether the storage operation is about to modify the at least one return address; and issuing, upon an affirmative determination, an error-alert signal to prevent the value from being stored to the write address of the at least one storage block.

The computing devices and the methods for the computing device, as provided by the present disclosure, are effective in storing a storage address of a return address in a call stack to a store-once stack when storing a return address of a program to the call stack, effective in determining, in the course of execution of the program with a comparison logic circuit, whether a storage operation performed on the call stack will modify the return address, and thus effective in detecting return-oriented programming attacks and precluding modification of the return address in the call stack.

### BRIEF DESCRIPTION OF THE DRAWINGS

Persons skilled in the art can better understand various aspects of the disclosure by referring to the accompanying drawings and embodiments of the disclosure. In view of conventional standards and practice, the accompanying drawings are not drawn to scale. In fact, for the sake of illustration, the drawing scale of the accompanying drawings is adjustable as needed.

FIG. 1 is a schematic view of a computing device according to an embodiment of the disclosure.

FIG. 2 is a flowchart of a method for a computing device according to an embodiment of the disclosure.

FIG. 3 is a schematic view of a call stack of the disclosure.

FIG. 4 is a schematic view of operation of the computing device of FIG. 1 when executing a storage operation on the call stack to push in a value.

FIG. 5 is a schematic view of a comparison logic circuit according to an embodiment of the disclosure.

FIG. 6 is a schematic view of a computing device according to another embodiment of the disclosure.

FIG. 7 is a schematic view of contents stored in a store-once stack of the disclosure.

FIG. 8 is a schematic view of how the computing device of FIG. 6 carries out steps of the method of FIG. 2.

FIG. 9 is a schematic view of how the computing device of FIG. 6 carries out steps of the method of FIG. 2 according to another embodiment of the disclosure.

FIG. 10 is a schematic view of how the computing device of FIG. 6 carries out steps of the method of FIG. 2 according to another embodiment of the disclosure.

FIG. 11 is a circuit diagram of issuing a storage request to an access detection unit in a reorder buffer of FIG. 2.

FIG. 12 is a circuit diagram of issuing a release request to the access detection unit in the reorder buffer of FIG. 2.

### DETAILED DESCRIPTION OF THE EMBODIMENTS

The following disclosure provides various different embodiments or examples for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various embodiments. This repetition is for the purpose of simplicity and clarity and does not in itself dictate a relationship between the various embodiments and/or configurations discussed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “generally” means within an acceptable standard error of the mean when considered by one of ordinary skill in the art. As could be appreciated, other than in the operating/working examples, or unless otherwise expressly specified, all of the numerical ranges, amounts, values, and percentages (such as those for quantities of materials, duration of times, temperatures, operating conditions, portions of amounts, and the likes) disclosed herein should be understood as modified in all instances by the term “generally.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Here, ranges can be expressed herein as from one endpoint to another endpoint or between two endpoints. All ranges disclosed herein are inclusive of the endpoints, unless specified otherwise.

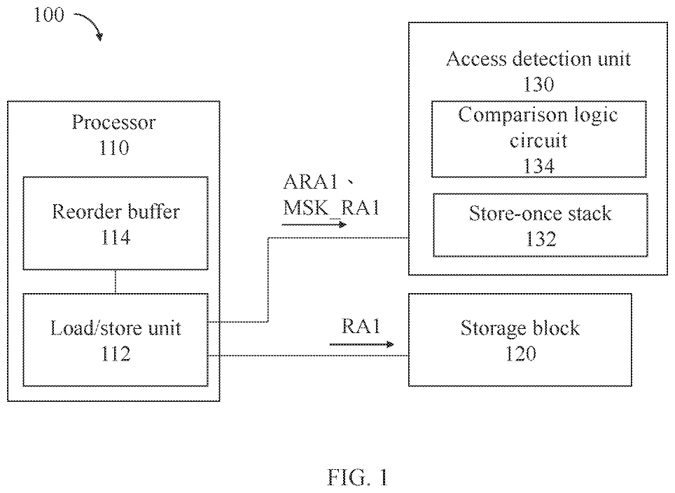

FIG. 1 is a schematic view of a computing device 100 according to an embodiment of the disclosure. The computing device 100 comprises a processor 110, a storage block 120 and an access detection unit 130. The processor 110 comprises a load/store unit (LSU) 112 and a reorder buffer 114. The access detection unit 130 comprises a store-once stack 132 and a comparison logic circuit 134. In the present embodiment, the processor 110 executes a program generated by compiling a program code. When the processor 110 executes a specific instruction, such as a function call instruction or a jump instruction, the processor 110 would exit the current program and enter another program requested by the instruction. However, before the processor 110 begins to execute the new program, the computing device 100 may use the load/store unit 112 to store a return address RA1 of the new program in the storage block 120 to ensure that, upon completion of the new program, the processor 110 will go back to the origin program according to the return address RA1 so as to continue with the execution.

Furthermore, in the present embodiment, the computing device 100 stores a storage address ARA1 in the storage block 120 where the return address RA1 is stored to a store-once stack 132. Thus, in the subsequent course of execution of the new program by the processor 110, whenever the load/store unit 112 has to perform a storage operation on the storage block 120 to store new data therein, the comparison logic circuit 134 would compare the write address of the storage operation with the storage address ARA1 in the store-once stack 132 and determine whether the storage operation to be performed on the storage block 120 will modify the return address RA1 stored in the storage block 120 and thus determines whether to permit such storage operation. As a result, the return address RA1 can be protected from being overwritten, thereby protecting the computing device 100 from being compelled to execute malware and causing information security breaches or system damage.

In some embodiments, the computing device 100 may include a memory (not shown in FIG. 1) and may allocate two independent storage spaces in the memory for the store-once stack 132 and the storage block 120 respectively, that is, the store-once stack 132 and the storage block 120 can be implemented by two independent storage spaces in the memory. Furthermore, in some embodiments, the store-once stack 132 can sequentially set addresses for newly pushed-in data in a circular manner so as to simplify the use of the store-once stack 132, but the disclosure is not limited thereto.

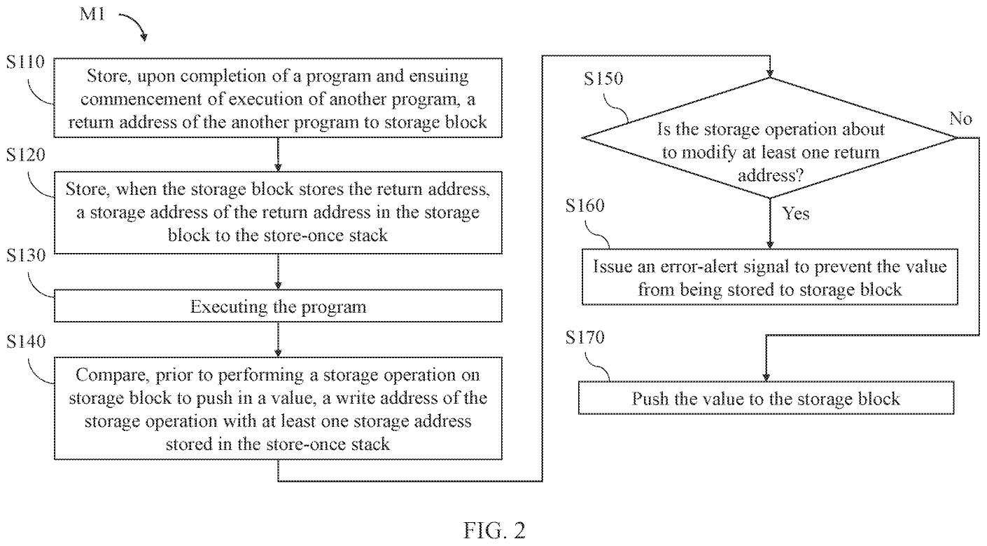

FIG. 2 is a flowchart of a method M1 for a computing device according to one embodiment of the disclosure. The method M1 includes steps S110˜S170 and is applicable to the computing device 100. In the present embodiment, when the processor 110 executes a specific instruction, such as a function call instruction or a jump instruction, the processor 110 has to get ready for exiting the current program and entering a new program, for example, a program segment specified by the function or jump instruction to call. Before executing the new program, the computing device 100 in step S110 may store the return address RA1 of the new program to be executed in the storage block 120.

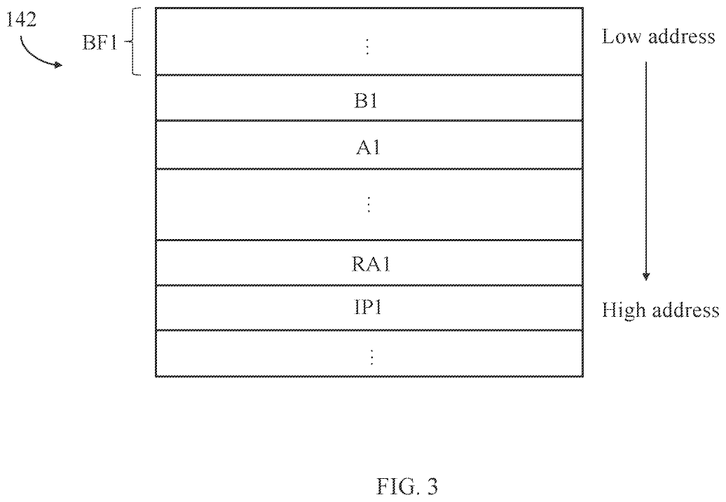

FIG. 3 is a schematic view of the storage block 120 of the disclosure. In the present embodiment, the storage block 120 can be, for example, a call stack for storing parameters required for executing the program. As shown in FIG. 3, the return address RA1 and the input parameter IP1 for the new program to be executed are sequentially pushed in the storage block 120. In the present embodiment, the input parameter for the new program is exemplified by one parameter IP1, but the disclosure is not limited thereto. In some embodiments, the new program may require more than one input parameter or may not require any input parameter. Accordingly, the input parameters would be pushed in the storage block 120, or no input parameter is pushed in the storage block 120. Furthermore, prior to the execution of the new program, the storage block 120 may further reserve a storage space for storing local parameters required by the new program, for example, the parameters A1 and B1 that are required or declared in the new program can be sequentially pushed in the storage block 120. Furthermore, the storage block 120 may reserve a buffer block BF1 to satisfy the need for data storage in the course of program execution, and the base address of the storage block 120 may gradually move from a lower address to a higher address as pieces of data are pushed in the buffer block BF1 of the storage block 120. Therefore, when excessive data are pushed in the buffer block BF1 and overflows, the overflowing data may overwrite the previously-stored data and even takes up the storage space for storing the return address RA1, thereby overwriting the return address RA1 and causing failure to return the origin program upon completion of execution of the new program.

In order to protect the return address RA1 from being overwritten, in step S120, when the return address RA1 is stored to the storage block 120, the computing device 100 can further store the storage address ARA1 of the return address RA1 in the storage block 120 to the store-once stack 132, so as to serve as a basis for determining whether the return address RA1 will be overwritten in the future operations.

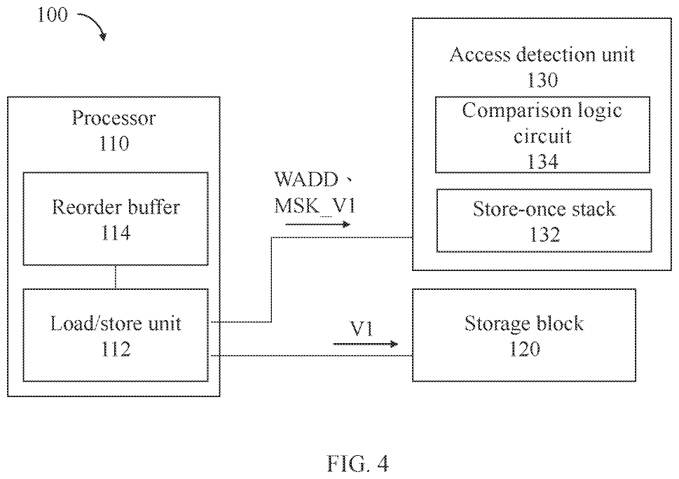

In step S130, the processor 110 begins to execute a new program. When the processor 110 needs to store data to the storage block 120 in the course of execution of the new program, the processor 110 may perform steps S140 and S150 to determine whether such storage operation will modify the return address RA1 and, upon a negative determination, perform the storage operation to store the data to the storage block 120. FIG. 4 is a schematic view of operation of the computing device 100 when performing a storage operation on the storage block 120 to push in a value V1.

As shown in FIG. 4, before the load/store unit 112 performs the storage operation on the storage block 120 to push in value V1, the comparison logic circuit 134 can compare in step S140 the write address WADD of the storage operation with the storage address ARA1 of the return address RA1 stored in the store-once stack 132 and determines, in step S150, whether the storage operation will modify the value of return address RA1 according to the comparison result of step S140. In the present embodiment, if the write address WADD is identical to the storage address ARA1 of the return address RA1, it may imply that the value V1 is about to be used to overwrite the return address RA1 after the value V1 has been stored to the write address WADD, thereby modifying the return address RA1. By contrast, if the write address WADD is different from the storage address ARA1 of the return address RA1, it may imply that pushing the value to the write address WADD will not modify the value of the return address RA1. In the present embodiment, with the storage block 120 being a call stack, the write address WADD of the storage operation performed by the load/store unit 112 would be the base address of the call stack.

In step S150, when it is determined that the value of return address RA1 is about to be modified, it may imply that the return-oriented programming attack is detected. At this point, step S160 can be performed to issue an error-alert signal and stop pushing the value V1 in write address WADD of the storage block 120. However, if in step S150 it is determined that the value of the return address RA1 is unlikely to be modified, step S170 will be carried out to store the value V1 to the write address WADD of the storage block 120, thereby finishing the storage operation.

However, it is possible that the return address RA1 does not take up the whole storage space corresponding to storage address ARA1. For instance, the storage address ARA1 may be corresponding to a storage space for storing 32 bits of data, but the data of return address RA1 includes only 16 bits in length. In such case, if the data length of the value V1 is also 16 bits, while the return address RA1 is stored to the lower 16 bits, then it is feasible to store the value V1 in the higher 16 bits in the storage address ARA1 without modifying the return address RA1. Thus, when the write address WADD and the storage address ARA1 are identical, it is feasible to further compare a valid bit mask MSK_V1 of the value V1 with a valid bit mask MSK_RA1 of the return address RA1 to determine whether they are identical and thus further confirm whether they correspond to the same bit in the same address, so as to confirm whether allowing the value V1 to be pushed in the storage block 120 will lead to overwriting the contents of return address RA1.

For instance, the method M1 may not only entail storing the storage address ARA1 of the return address RA1 to the store-once stack 132 in step S120, but also entail storing the valid bit mask MSK_RA1 that corresponds to the return address RA1 to the store-once stack 132. Thus, the method M1 can not only entail comparing the write address WADD with the storage address ARA1 in step S140, but also entail comparing the valid bit mask MSK_V1 of the value V1 and the valid bit mask MSK_RA1 of the return address RA1 with the comparison logic circuit 134, thereby allowing step S150 to determine whether the storage operation is about to modify return address RA1 even more precisely.

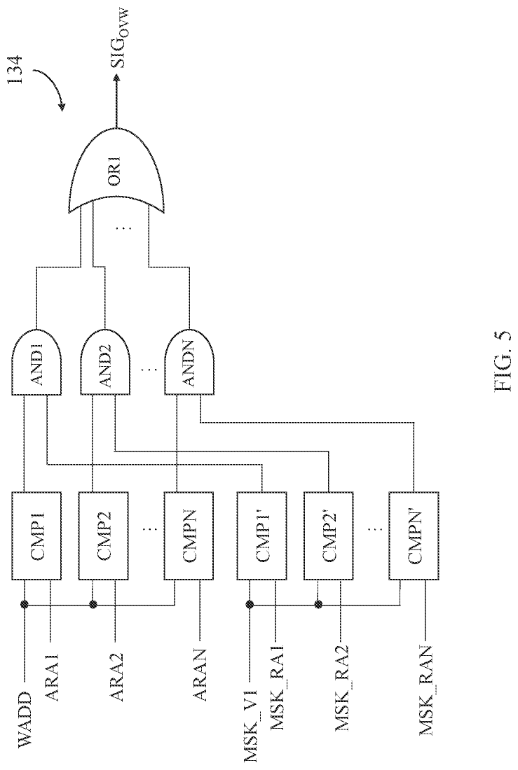

FIG. 5 is a schematic view of the comparison logic circuit 134 according to one embodiment of the present disclosure. In the present embodiment, the store-once stack 132 can store simultaneously a maximum N storage addresses ARA1˜ARAN of return addresses RA1˜RAN, whereas the comparison logic circuit 134 may include comparators CMP1˜CMPN, comparators CMP1′˜CMPN′, logic AND gates AND1˜ANDN, and logic OR gate OR1, where N is an integer greater than 1.

As shown in FIG. 5, the comparators CMP1˜CMPN can compare the write address WADD of the storage operation to be performed with the storage addresses ARA1˜ARAN, whereas the comparators CMP1‘˜CMPN’ can compare the valid bit mask MSK_V1 of the value V1 of the storage operation with the valid bit masks MSK_RA1˜MSK_RAN of the return addresses RA1˜RAN. For instance, the comparator CMP1 compares the write address WADD with the storage address ARA1, and the comparator CMP2 compares the write address WADD with the storage address ARA2. Similarly, the comparator CMP1′ compares the valid bit mask MSK_V1 of the value V1 with the valid bit mask MSK_RA1 of the return address RA1, and the comparator CMP2′ compares the valid bit mask MSK_V1 of the value V1 with the valid bit mask MSK_RA2 of the return address RA2.

Then, the logic AND gates AND1˜ANDN can perform logic AND operations on output values of the comparators CMP1˜CMPN and output values of the comparators CMP1‘˜CMPN’, and the logic OR gate OR1 can perform a logic OR operation on output values of the logic AND gates AND1‘˜ANDN’, thereby outputting an overwrite determination signal SIG_{OVW}.

In the present embodiment, when any one of the storage addresses ARA1˜ARAN is identical to the write address WADD, and the valid bit mask of the return address corresponding to the storage address identical to the write address WADD is identical to valid bit mask MSK_V1 of value V1, the comparison logic circuit 134 can output the overwrite determination signal SIG_{OVW} with a value of 1, indicating that the comparison logic circuit 134 determines that the storage operation to execute is about to cause modification of the return address stored in the storage block 120. By contrast, if the write address WADD is identical to none of the storage addresses ARA1˜ARAN, it means that the storage operation to be performed will not cause modification of the return address stored in the storage block 120, and thus the comparison logic circuit 134 can output overwrite determination signal SIG_{OVW} with a value of 0.

Furthermore, if the write address WADD is identical to one of storage addresses ARA1˜ARAN but there is mutual exclusion between the valid bit mask of the return address corresponding to the storage address identical to write address WADD and the valid bit mask MSK_V1 of the value V1, it may imply that both the value V1 and the return address RA1 can be stored to the same storage address ARA1 while the value V1 will not overwrite the value of the return address RA1. Therefore, the storage operation to be performed will not cause modification of the return address stored in the storage block 120. In such case, the comparison logic circuit 134 can output the overwrite determination signal SIG_{OVW} with a value of 0 to indicate that the comparison logic circuit 134 determines that the storage operation to be performed will not cause modification of the return address of the storage block 120.

Since the computing device 100 can use the hardware of the comparison logic circuit 134 to detect whether the return address will be modified, it can effectively detect the return-oriented programming attacks and protect the return addresses from being modified without making great changes to operating systems.

In the embodiment illustrated by FIG. 1, the storage block 120 is a call stack for storing program parameters, but the disclosure is not limiting to protecting the return addresses in the call stack. In some embodiments, the storage block can be a buffer block corresponding to a Longjump instruction. The buffer block of the Longjump instruction also stores a return address when a program jumps, and thus the return address stored in the buffer block can also be protected by a store-once stack.

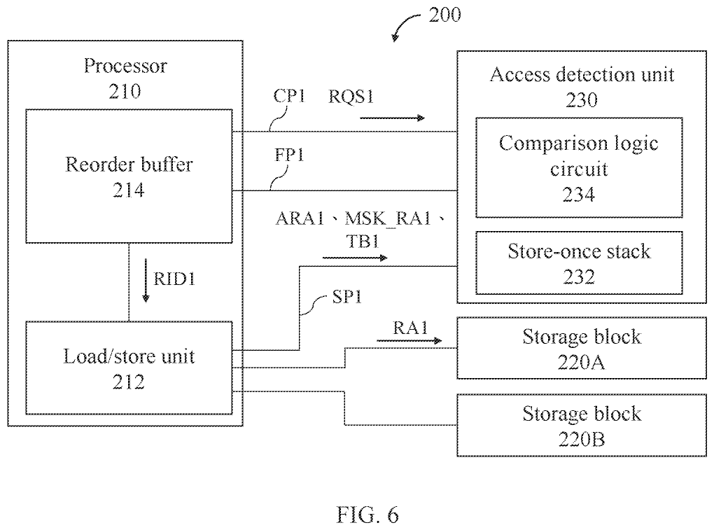

FIG. 6 is a schematic view of a computing device according to another embodiment of the disclosure. A computing device 200 of FIG. 6 and the computing device 100 of FIG. 1 are similar in structures and can be operated according to similar principles. However, unlike the computing device 100, the computing device 200 includes two storage blocks 220A and 220B, wherein the storage block 220A is, for example, a call stack for use with a function call, and the storage block 220B is, for example, a buffer block for use with a Longjump instruction.

Furthermore, in the computing device 100 shown in FIG. 1, the reorder buffer 114 can issue instructions in a program to a computation unit (not shown in FIG. 1), such as an arithmetic logic unit (ALU) and/or the load/store unit 112, in the processor 110 for execution, and can assign a specific number to each instruction so as to record the statuses of the instructions in terms of execution. Since the reorder buffer 114 can commit, in a predetermined order, a plurality of instructions that were executed without obeying the predetermined order, although the processor 110 does not necessarily execute the instructions in the predetermined order, the final commitment order of the instructions after execution would still conforms with the predetermined order, so as to ensure that the program can be correctly executed. In the computing device 200 shown in FIG. 6, a reorder buffer 214 has the same capability as the reorder buffer 114, and can control the load/store unit 212 to perform a storage operation and a read operation on the storage blocks 220A and 220B, and control the load/store unit 212 to perform a storage operation and a read operation on the store-once stack 232.

As shown in FIG. 6, a processor 210 can be coupled to an access detection unit 230 through a storage pipeline SP1, a commit pipeline CP1 and a detection pipeline FP1 and use the reorder buffer 214 to control the access detection unit 230 to perform step S120. In the present embodiment, the storage pipeline SP1, the commit pipeline CP1 and the detection pipeline FP1 are, for example, buses in the system.

In step S120, when the reorder buffer 214 commits a storage instruction for storing the return address RA1 to the storage block 220A, the reorder buffer 214 can send the storage instruction ID RID1 to the load/store unit 212 so as to allow the load/store unit 212 to accordingly send the storage address ARA1 of the return address RA1 involved in the storage instruction to the store-once stack 232 via the storage pipeline SP1. Furthermore, when committing the storage instruction, the reorder buffer 214 can further determine whether the storage address ARA1 of return address RA1 corresponds to a pointer of the call stack, i.e., the storage block 220A. If the storage address ARA1 of the return address RA1 is corresponding to the pointer of the call stack, it means that the return address is corresponding to a function call instruction, and the reorder buffer 214 would issue a first-type storage request RQS1 to the store-once stack 232, such that the store-once stack 232 can store a first-type bit TB1 along with the storage address ARA1 and, thereby indicating that the storage address ARA1 corresponds to the call stack.

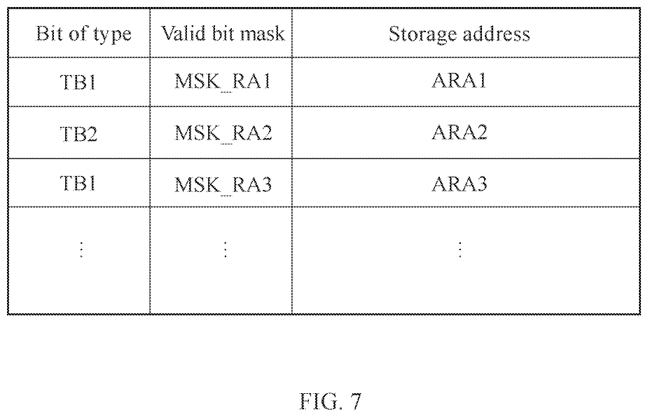

FIG. 7 is a schematic view of contents stored in the store-once stack 232. As shown in FIG. 7, the store-once stack 232 stores the storage addresses ARA1, ARA2 and ARA3, and their respective valid bit masks MSK_RA1, MSK_RA2 and MSK_RA3. Furthermore, the storage addresses ARA1 and ARA3 are corresponding to pointers of the call stack, and in consequence, the storage addresses ARA1 and ARA3 are corresponding to first-type bits TB1. By contrast, since the storage address ARA2 of return address RA2 does not correspond to a pointer of the call stack, it may means that the return address is corresponding to a jump instruction. Thus, before requesting the load/store unit 212 to store the storage address ARA2 to the store-once stack 232, the reorder buffer 214 may issue a second-type storage request to the store-once stack 232, such that the store-once stack 232 stores the second-category bit TB2 along with the storage address ARA2, indicating that storage address ARA2 is corresponding to the buffer block.

Furthermore, in the present embodiment, when committing the storage instruction, the reorder buffer 214 can further have the load/store unit 212 send the storage address ARA1 and the valid bit mask MSK_RA1 that are corresponding to the return address RA1 to the store-once stack 232 via the storage pipeline SP1. As a result, in steps S140 and S150, the comparison logic circuit 234 can read the storage addresses ARA1˜ARAN of the return addresses RA1˜RAN and the valid bit masks MSK_RA1˜MSK_RAN from the store-once stack 232 for according comparison and determination.

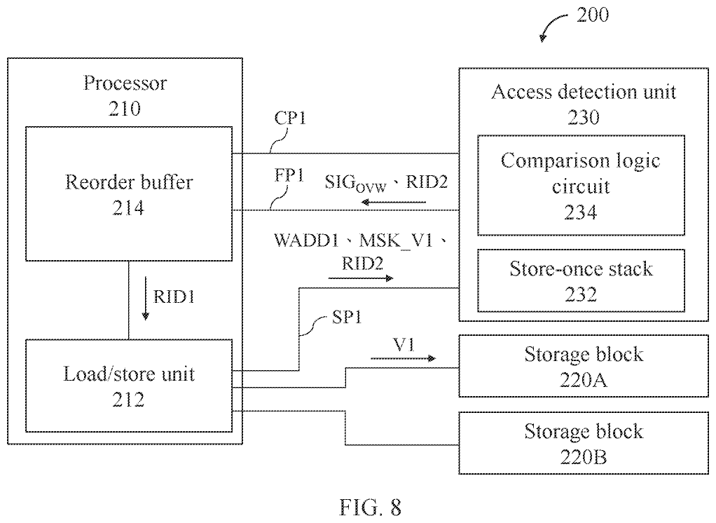

FIG. 8 is a schematic view of how a computing device 200 carries out steps S140 and S150. As shown in FIG. 8, when the reorder buffer 214 needs to have the load/store unit 212 perform the storage operation for storing the value V1 in the storage block 220A according to write address WADD1, the reorder buffer 214 can send the instruction ID RID2 of the storage operation in the reorder buffer 214 to the load/store unit 212, allowing the load/store unit 212 to perform the storage operation. However, as described in step S140, before performing the storage operation on the storage block 220A, the load/store unit 212 can send the write address WADD1 of the storage operation and the valid bit mask MSK_V1 of the value V1 to the access detection unit 230 via the storage pipeline SP1, and perform the comparison with the comparison logic circuit 234, so as to determine whether the storage operation will modify the return address RA1 in step S150.

Furthermore, owing to the preceding operation, the store-once stack 232 may store both a return address that corresponds to a call stack and a return address that corresponds to a buffer block, therefore, in the embodiment illustrated by FIG. 8, the comparison logic circuit 234 may compare the write address WADD1 only with at least one storage address of at least one return address that corresponds to the first-type bit TB1 in the store-once stack 232, thereby dispensing with the need to compare the write address WADD1 with all the storage addresses in the store-once stack 232. As a result, it is feasible to efficiently determine whether the current storage operation will modify a return address in a call stack.

In the present embodiment, if the comparison logic circuit 234 determines that the storage operation will modify return address RA1, it can issue the error-alert signal SIG_{OVW} via the detection pipeline FP1, so as to preclude pushing the value V1 into the storage address ARA1 of the return address RA1. Furthermore, in some embodiments, to provide the system with more error-detecting information, the load/store unit 212 may send the write address WADD and the valid bit mask MSK_V1 to the access detection unit 230 together with the instruction ID RID2 of the storage operation. Thus, the comparison logic circuit 234 can not only issue the error-alert signal SIG_{OVW} to the reorder buffer 214 but also issue the instruction ID RID2 to the reorder buffer 214, allowing the reorder buffer 214 to identify the instruction caused error and perform a corresponding error-tackling procedure.

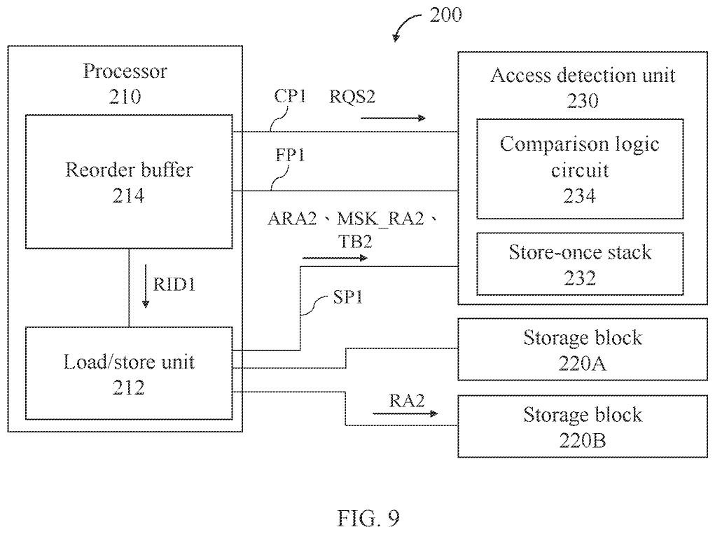

FIG. 9 is a schematic view of how the computing device 200 carries out step S120 according to another embodiment of the present disclosure. In the present embodiment, when the reorder buffer 214 commits the storage instruction for storing the return address RA2 to the storage block 220B, the reorder buffer 214 can send the instruction ID RID3 of the storage instruction to the load/store unit 212, thereby allowing the load/store unit 212 to send the storage address ARA2 of the return address RA2 involved in the storage instruction to the store-once stack 232 via the storage pipeline SP1. Furthermore, when committing the storage instruction, the reorder buffer 214 can further determine whether the storage address ARA2 of the return address RA2 is corresponding to the pointer of the call stack, i.e., the storage block 220A. In the embodiment illustrated by FIG. 9, the storage address ARA2 of the return address RA2 does not correspond to the pointer of the call stack, indicating that the return address RA2 is corresponding to a jump instruction, and in consequence, the reorder buffer 214 can issue the second-type storage request RQS2 to the store-once stack 232, thereby allowing the store-once stack 232 to store the storage address ARA2 and the second-category bits TB2, so as to indicate that storage address ARA2 is corresponding to the buffer block.

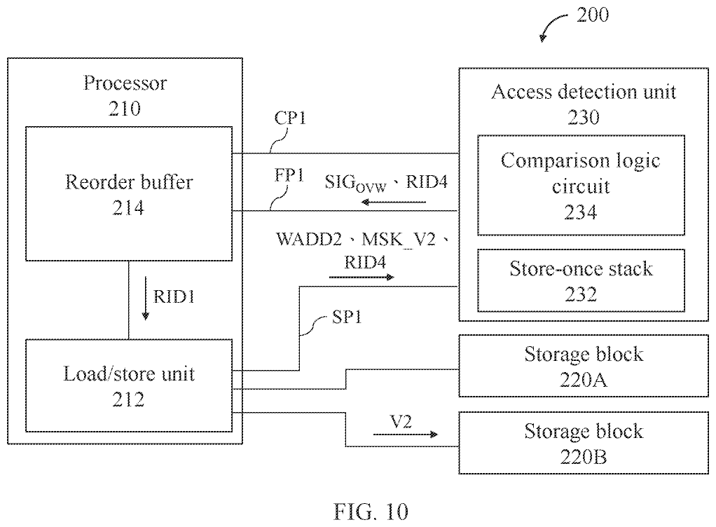

FIG. 10 is a schematic view of how the computing device 200 carries out steps S140 and S150 according to another embodiment of the present disclosure. As shown in FIG. 10, when the reorder buffer 214 needs to have the load/store unit 212 perform a storage operation of value V2 on the storage block 220B according to the write address WADD2, the reorder buffer 214 can send the instruction ID RID4 of the storage operation in the reorder buffer 214 to the load/store unit 212, so that the load/store unit 212 can perform the storage operation. However, as described in step S140, before performing the storage operation on the storage block 220B, the load/store unit 212 can send the valid bit mask MSK_V2 of the value V2 and the write address WADD2 of the present storage operation to the access detection unit 230 via the storage pipeline SP1 for performing the comparison by the comparison logic circuit 234. As such, step S150 entails determining whether the storage operation will modify the return address RA2 in the storage block 220B.

Furthermore, owing to the preceding operation, the store-once stack 232 may have stored a return address corresponding to a call stack and a return address corresponding to a buffer block, therefore, in the embodiment illustrated by FIG. 10, the comparison logic circuit 234 can compare the write address WADD2 with at least one storage address of at least one return address that is corresponding to the second-category bit TB2 in the store-once stack 232, thereby dispensing with the need to compare the write address WADD2 with all the storage addresses in the store-once stack 232. Thus, it is feasible to efficiently determine whether the current storage operation will modify a return address in the buffer block.

In the present embodiment, if the comparison logic circuit 234 determines that the storage operation will modify the return address RA2, it can issue the error-alert signal SIG_{OVW} via the detection pipeline FP1, so as to preclude pushing the value V2 into the storage address ARA2 of the return address RA2. Furthermore, in some embodiments, to further provide the system with more error-detecting information, the load/store unit 212 can not only send the write address WADD2 and the valid bit mask MSK_V2 to the access detection unit 230, but also send the instruction ID RID4 of the current storage operation to the access detection unit 230. As a result, when the comparison logic circuit 234 issues the error-alert signal SIG_{OVW} to the reorder buffer 214, it can also issue the instruction ID RID4 to the reorder buffer 214, allowing the reorder buffer 214 to identify the instruction that caused error and execute a corresponding error-tackling procedure.

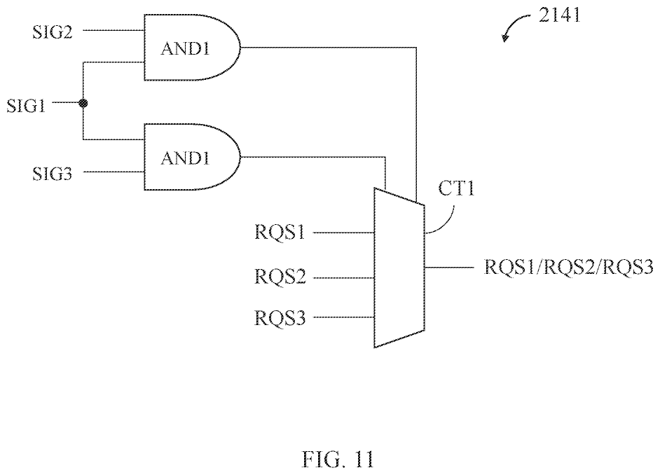

FIG. 11 is a circuit diagram of issuing a storage request to the access detection unit 230 in the reorder buffer 214. In the present embodiment, the reorder buffer 214 includes a logic circuit 2141, and the logic circuit 2141 includes AND gates AND1, AND2 and a control circuit CT1. As shown in FIG. 11, the AND gate AND1 may receive a storage instruction determination signal SIG1 and a return address determination signal SIG2, and the AND gate AND2 can receive the storage instruction determination signal SIG1 and a storage address determination signal SIG3. In the present embodiment, when the reorder buffer 214 needs to perform a storage instruction to the storage block 220A or 220B, the storage instruction determination signal SIG1 is logic 1, otherwise the storage instruction determination signal SIG1 is logic 0. When the reorder buffer 214 needs to store the return address to the storage block 220A or 220B, the return address determination signal SIG2 is logic 1, otherwise the return address determination signal SIG2 is logic 0. Also, when the storage address of the return address corresponds to a pointer of the call stack, the storage address determination signal SIG3 is logic 1, otherwise the storage address determination signal SIG3 is logic 0. In such case, the control circuit CT1 can issue the first-type storage request RQS1 to the access detection unit 230 when both the outputs of the AND gates AND1 and AND2 are logic 1, and issue the second-type storage request RQS2 to the access detection unit 230 when the output of the AND gate AND1 is logic 1 while the output of the AND gate AND2 is logic 0. Furthermore, in some embodiments, if the AND gate AND1 has an output of logic 0, and the AND gate AND2 has an output of logic 1, it means that the storage operation to be performed by the reorder buffer 214 is not intended to store a return address, and thus the control circuit CT1 can issue the third-type storage request RQS3 to the access detection unit 230 to cause the comparison logic circuit 234 to prepare for comparison of storage addresses. In the present embodiment, the control circuit CT1 can be a multiplexer for outputting the first-type storage request RQS1, the second-type storage request RQS2 and the third-type storage request RQS3 according to output signals of the AND gates AND1 and AND2, however, the disclosure is not limited thereto. In some other embodiments, the reorder buffer 214 may effectuate determination according to other signals as needed, and generate the first-type storage request RQS1, the second-type storage request RQS2 and the third-type storage request RQS3 accordingly.

Upon completion of the execution of the new program, the reorder buffer 214 can control the load/store unit 212 to read the return address RA1 from the storage block 220A or read the return address RA2 from the storage block 220B and prepare for their return to the origin program. In such case, the storage addresses ARA1 and ARA2 of return addresses RA1 and RA2 stored in the store-once stack 232 will become invalid, therefore, to manage the storage space of the store-once stack 232 efficiently, the store-once stack 232 can pop the return addresses RA1 and ARA2 when the return addresses RA1, ARA2 are read, respectively and correspondingly. However, the store-once stack 232 can manage the storage space of the store-once stack 232 in different ways, depending on the type of the initial instruction that triggers the new program.

For instance, the reorder buffer 214 can issue the first-type release request to have the store-once stack 232 pop the storage address ARA1 upon satisfaction of two criteria: the reorder buffer 214 commits a load instruction for reading the return address RA1 from the storage block 220A; and the read address of the load instruction corresponds to the pointer of the call stack. By contrast, if the read address of the load instruction does not correspond to the pointer of the call stack when the reorder buffer 214 commits a load instruction for reading return address RA2 from the storage block 220B, indicating that return address RA2 may correspond to the return address of a jump instruction. Upon the return of the jump instruction, all the storage addresses in the store-once stack 232 will become invalid. Thus, the reorder buffer 214 can issue a second-type release request to have the store-once stack 232 to pop all the storage addresses therein.

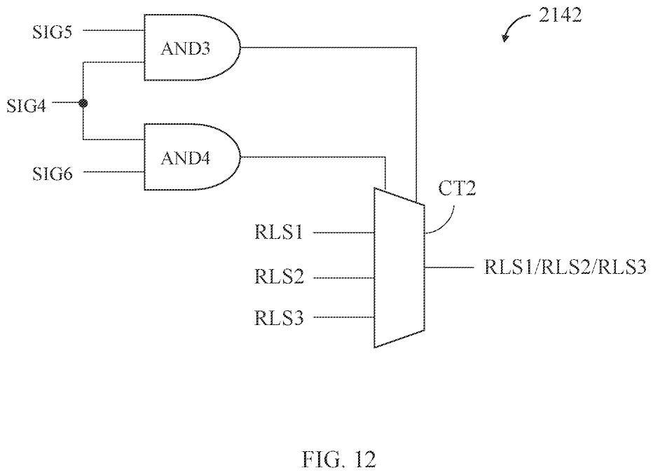

FIG. 12 is a circuit diagram of issuing a release request to the access detection unit 230 in the reorder buffer 214. In the present embodiment, the reorder buffer 214 includes a logic circuit 2142, and the logic circuit 2142 include AND gates AND3 and AND4 and a control circuit CT2. As shown in FIG. 12, the AND gate AND3 can receive a load instruction determination signal SIG4 and a return address determination signal SIG5, and the AND gate AND4 can receive the load instruction determination signal SIG4 and a storage address determination signal SIG6. In the present embodiment, when the reorder buffer 214 needs to perform a load instruction on the storage block 220A or 220B to thereby read data therein, the load instruction determination signal SIG4 is logic 1, otherwise the load instruction determination signal SIG4 is logic 0. When the reorder buffer 214 needs to read a return address from the storage block 220A or 220B, the return address determination signal SIG5 is logic 1, otherwise the return address determination signal SIG5 is logic 0. Also, when the storage address of the return address corresponds to the pointer of the call stack, the storage address determination signal SIG6 is logic 1, otherwise the storage address determination signal SIG6 is logic 0. In such case, the control circuit CT2 can issue the first-type release request RLS1 to the access detection unit 230 to have the store-once stack 232 pop a related storage address when the outputs of the AND gates AND3 and AND4 are logic 1, and issue the second-type release request RLS2 to the access detection unit 230 when the output of the AND gate AND3 is logic 1 while the output of the AND gate AND4 is logic 0, thereby allowing the store-once stack 232 to pop all the storage addresses therein. Furthermore, in some embodiments, if the output of the AND gate AND3 is 0, and the output of the AND gate AND4 is 1, it may imply that the load operation to be performed by the reorder buffer 214 has nothing to do with a return address, and in consequence, the control circuit CT2 can issue the third-type release request RLS3 to the access detection unit 230 so as to prevent the store-once stack 232 from operating erroneously. In the present embodiment, the control circuit CT2 can be a multiplexer for outputting the first-type release request RLS1, the second-type release request RLS2 and the third-type release request RLS3 according to output signals of AND gates AND3, AND4, respectively and correspondingly, however, the present disclosure is not limited thereto. In some other embodiments, the reorder buffer 214 may effectuate determination according to other signals as needed and generate the first-type release request RLS1, the second-type release request RLS2 and the third-type release request RLS3 accordingly.

Furthermore, in some embodiments, the processor 210 may interrupt the execution of the current program according to the system requirement, and the access detection unit 230 may temporarily transfer the data stored in the store-once stack 232 to another storage space of the memory, allowing the access detection unit 230 to restore the store-once stack 232 with the temporarily-stored data when execution of the otherwise interrupted program resumes.

In summary, the computing devices and the methods for the computing device, as provided by the present disclosure, are effective in storing a storage address of a return address in a call stack to a store-once stack when storing a return address of a program to the call stack, effective in determining, in the course of execution of the program with a comparison logic circuit, whether a storage operation performed on the call stack will modify the return address, and thus effective in detecting return-oriented programming attacks and precluding modification of the return address in the call stack. Furthermore, a store-once stack mechanism of the disclosure can also protect the return address stored in a buffer block of a jump instruction and thereby provide a better protection to the system.

The foregoing description briefly sets forth the features of certain embodiments of the present application so that persons having ordinary skill in the art more fully understand the various aspects of the disclosure of the present application. It will be apparent to those having ordinary skill in the art that they can easily use the disclosure of the present application as a basis for designing or modifying other processes and structures to achieve the same purposes and/or benefits as the embodiments herein. It should be understood by those having ordinary skill in the art that these equivalent implementations still fall within the spirit and scope of the disclosure of the present application and that they may be subject to various variations, substitutions, and alterations without departing from the spirit and scope of the present disclosure.

What is claimed is:

1. A computing device, comprising:
at least one storage block;
a processor configured to execute a program and comprising a load/store unit, wherein, when the processor exits the program and enters another program, the load/store unit stores a return address that the processor should return to after the another process finishes to the at least one storage block; and
an access detection unit comprising:
a store-once stack configured to store a storage address of the return address in the at least one storage block when the at least one storage block stores the return address; and
a comparison logic circuit configured to, before the load/store unit performs a storage operation on the at least one storage block to store a value, compare a write address of the storage operation with at least one storage addresses of at least one return address stored in the store-once stack to determine whether the storage operation is about to modify the at least one return address, and, upon an affirmative determination, and issue an error-alert signal to prevent the load/store unit from performing the storage operation and storing the value to the write address of the at least one storage block.

2. The computing device of claim 1, wherein the store-once stack is further configured to store a valid bit mask corresponding to the return address when the at least one storage block stores the return address, and the comparison logic circuit is further configured to compare a valid bit mask of the value with at least one valid bit mask corresponding to the at least one return address to determine whether the storage operation is about to modify the at least one return address.

3. The computing device of claim 1, wherein the processor further comprises a reorder buffer configured to:
record execution states of a plurality of instructions;
commit, in a predetermined order, a plurality of instructions that were executed without obeying the predetermined order; and
have the load/store unit store the storage address of the return address in the at least one storage block to the store-once stack when the reorder buffer commits a storage instruction for storing the return address to the at least one storage block.

4. The computing device of claim 3, wherein the reorder buffer is further configured to have the load/store unit store a valid bit mask corresponding to the return address to the store-once stack along with the storage address when committing the storage instruction.

5. The computing device of claim 3, wherein the at least one storage block comprises a call stack configured to store program parameters, and the reorder buffer is further configured to issue a first-type storage request when the storage address of the return address corresponds to a pointer of the call stack so as to have the store-once stack store a first-type bit along with the storage address for indicating that the storage address is corresponding to the call stack.

6. The computing device of claim 5, wherein, before the load/store unit performs the storage operation on the call stack to store the value, the comparison logic circuit compares the write address of the storage operation with at least one storage address of at least one return address that corresponds to the first-type bit in the store-once stack to determine whether the storage operation is about to modify the at least one return address.

7. The computing device of claim 5, wherein the reorder buffer is further configured to issue a first-type release request to have the store-once stack to pop the storage address when a load instruction for reading the return address from the at least one storage block is committed and a read address of the load instruction corresponds to a pointer of the call stack.

8. The computing device of claim 5, wherein the at least one storage block comprises a buffer block corresponding to Longjump instructions, and the reorder buffer issues a second-type storage request when the storage address of the return address does not correspond to a pointer of the call stack so as to have the store-once stack store a second-type bit along with the storage address for indicating that the storage address is corresponding to the buffer block.

9. The computing device of claim 8, wherein, before the load/store unit performs the storage operation on the buffer block to store the value, the comparison logic circuit compares the write address of the storage operation with at least one storage address of at least one return address that corresponds to the second-type bit in the store-once stack to determine whether the storage operation is about to modify the at least one return address.

10. The computing device of claim 8, wherein the reorder buffer is further configured to issue a second-type release request to have the store-once stack pop all storage addresses stored therein when a load instruction for reading the return address from the at least one storage block is committed and a read address of the load instruction does not correspond to a pointer of the call stack.

11. The computing device of claim 3, wherein, after the comparison logic circuit has issued the error-alert signal, the load/store unit sends an instruction ID of the storage operation in the reorder buffer to the reorder buffer to have the reorder buffer execute a corresponding error-processing procedure.

12. A method for a computing device, the computing device comprising at least one storage block and a store-once stack, and the method comprising:
storing, upon completion of a program and ensuing commencement of execution of another program, a return address of the another program to the at least one storage block;
storing, when the at least one storage block stores the return address, a storage address of the return address in the at least one storage block to the store-once stack;
executing the another program;
comparing, prior to performing a storage operation on the at least one storage block to push in a value, a write address of the at least one storage block with at least one storage address of at least one return address stored in the store-once stack to determine whether the storage operation is about to modify the at least one return address; and
issuing, upon an affirmative determination, an error-alert signal to prevent the value from being stored to the write address of the at least one storage block.

13. The method of claim 12, further comprising:
storing, when the at least one storage block stores the return address, a valid bit mask corresponding to the return address to the store-once stack,
wherein the step of comparing the write address of the at least one storage block with the at least one storage address of the at least one return address stored in the store-once stack to determine whether the storage operation is about to modify the at least one return address comprises comparing a valid bit mask of the value with at least one valid bit mask corresponding to the at least one return address to determine whether the storage operation is about to modify the at least one return address.

14. The method of claim 12, wherein the computing device further comprises a reorder buffer, and the method further comprises:
committing, by the reorder buffer in a predetermined order, a plurality of instructions that were executed without obeying the predetermined order; and
sending, upon issuance of the error-alert signal, an instruction ID of the storage operation in the reorder buffer to the reorder buffer to have the reorder buffer execute a corresponding error-processing procedure.

15. The method of claim 12, wherein the at least one storage block comprises a call stack for storing program parameters, the method further comprising issuing, when the storage address of the return address corresponds to a pointer of the call stack, a first-type storage request so as to have the store-once stack store a first-type bit along with the storage address for indicating that the storage address is corresponding to the call stack.

16. The method of claim 15, wherein the step of comparing, prior to performing the storage operation on the at least one storage block to push in the value, the write address of the at least one storage block with the at least one storage address of the at least one return address stored in the store-once stack to determine whether the storage operation is about to modify the at least one return address comprises comparing, prior to performing the storage operation on the call stack to store the value, the write address of the storage operation with at least one storage address of at least one return address that corresponds to the first-type bit in the store-once stack to determine whether the storage operation is about to modify the at least one return address.

17. The method of claim 15, further comprising issuing, when a reorder buffer commits a load instruction for reading the return address from the at least one storage block and a read address of the load instruction corresponds to a pointer of the call stack, a first-type release request so as to have the store-once stack pop the storage address.

18. The method of claim 15, wherein the at least one storage block comprises a buffer block corresponding to Longjump instructions, the method further comprises issuing a second-type storage request when the storage address of the return address does not correspond to a pointer of the call stack so as to have the store-once stack store a second-type bit along with the storage address for indicating that the storage address is corresponding to the buffer block.

19. The method of claim 18, wherein the step of comparing, prior to performing the storage operation on the at least one storage block to push in the value, the write address of the at least one storage block with the storage address of the at least one return address stored in the store-once stack to determine whether the storage operation is about to modify the at least one return address comprises comparing, prior to performing the storage operation on the buffer block to store the value, the write address of the storage operation with at least one storage address of at least one return address that corresponds to the second-type bit in the store-once stack to determine whether the storage operation is about to modify the at least one return address.

20. The method of claim 19, further comprising issuing, when a reorder buffer commits a load instruction for reading the return address from the at least one storage block and a read address of the load instruction does not correspond to a pointer of the call stack, a second-type release request so as to have the store-once stack to pop all storage addresses stored therein.
